(19) United States
(12) Patent Application Publication
(10) Pub. No.: US 2004/0001404 A1
(43) Pub. Date: Jan. 1, 2004

(54) Data reading apparatus

(75) Inventor: Chitoshi Ambe, Kasugai (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: FUJITSU LIMITED

(21) Appl. No.: 10/602,914

(22) Filed: Jun. 25, 2003

(30) Foreign Application Priority Data
Jun. 27, 2002 (JP) 2002-187992

(51) Int. Cl. G11B 7/005

(52) U.S. Cl. 369/47.35

(57) ABSTRACT

A data reading apparatus, capable of reducing the recording field of a header portion, generates a read clock signal based on the average rotational speed and recording density of a disk. Delay circuits generate first and second delay clock signals of different phases. Three ID reading apparatuses operate in accordance with the read clock signal and the first and second delay clock signals to read address information at different timings. A selector circuit selects the best read address and error detection result from the read addresses and error detection results for the read addresses.

### CROSS-REFERENCE TO RELATED APPLICATION

This application is based upon and claims the benefit of priority from prior Japanese Patent Application No. 2002-187992, filed on Jun. 27, 2002, the entire contents of which are incorporated herein by reference.

### BACKGROUND OF THE INVENTION

The present invention relates to a data reading apparatus which reads data from a recording medium. More particularly, present invention relates to a data reading apparatus for reading data from a recording medium having a header portion in each sector.

Recently, a vast amount of data is recorded on a recording medium at a high recording density. Each sector of an MO (Magneto-Optical disk) and DVD-RAM (Digital Versatile Disk Random Access Memory) consists of a header portion and a data portion. Increasing the recording density and the capacity of recording media requires an improvement in the recording density in the data portion. In addition, increasing the substantial recording capacity of recording media requires that the recording field of the header portion be made smaller.

FIG. 1 shows a conventional apparatus which reads data from a disk 2, such as an MO or a DVD-RAM. A pickup 1 reads out data recorded on the disk 2 and provides an analog signal indicative of the data to a read channel section 3.

The read channel section 3 performs digital conversion on the analog signal to generate read data RDDATA and provides the read data RDDATA to a controller section 4. The read channel section 3 generates a read clock signal RDCLK, which is synchronous with the read data RDDATA, and provides the read clock signal RDCLK to the controller section 4.

The controller section 4 samples the read data RDDATA in accordance with the read clock signal RDCLK.

The controller section 4 is illustrated in FIG. 2. The read data RDDATA is provided to a decoder 5. The decoder 5 demodulates data from a channel bit (ch-bit) format to yield data in Byte format. A formatter 6 manages physical format information for demodulated data in the Byte format. An error correction section 7 performs error detection and error correction on the demodulated data in the Byte format.

The demodulated data in the Byte format and process results from the error correction section 7 are stored in a buffer memory 9 via a buffer manager 8. Data needed for data reproduction is transferred to an unillustrated reproducing section from the buffer memory 9.

FIG. 3 shows the sector format of a MO of 640 MB. Each sector consists of a header portion 10 and a data portion 11. The header portion 10 has a size of 63 Bytes, the data portion has a size of 2490 Bytes so that one sector amounts to 2584 Bytes.

The header portion 10 stores VFO (Variable Frequency Oscillator) fields VFO1 and VFO2, a 1-byte address mark AM following each VFO field and 5-byte physical addresses ID1 and ID2 each following the associated address mark AM. Each of the physical addresses ID1 and ID2 consists of a 3-bit ID portion and a 2-bit error detection code CRC.

At the time of reading data, while the VFO fields VFO1 and VFO2 are being read out, the read channel section 3 generates a read clock signal RDCLK synchronous with the read data RDDATA. The controller section 4 executes the operation of reading the read data RDDATA in accordance with the read clock signal RDCLK.

As shown in FIG. 4, the read data RDDATA is read one ch-bit at a time. The read cycle for one ch-bit read data RDDATA is t1. The read clock signal RDCLK that is synchronized with the read cycle t1 is generated in the read channel section 3. In response to the rising of the read clock signal RDCLK, the controller section 4 samples the read data RDDATA.

The formatter 6 in the controller section 4 is shown in FIG. 5. An AM detection circuit 12 is provided with the read clock signal RDCLK and read data RDDATA. Prior to reading the address mark AM, the AM detection circuit 12 receives an AM detection window signal W1 generated in the formatter 6.

When detecting the address mark AM in the read data RDDATA, the AM detection circuit 12 provides an address mark detection signal AMD to an ID reading circuit 13. The reading circuit 13 is provided with the read clock signal RDCLK, read data RDDATA and address mark detection signal AMD. When receiving the address mark detection signal AMD, the ID reading circuit 13 samples the physical addresses ID1 and ID2 included in the read data RDDATA according to the read clock signal RDCLK and provides the sampled addresses as a read address IDR to an ID decision circuit 14.

The ID decision circuit 14 determines the read address IDR based on the read clock signal RDCLK. That is, the ID decision circuit 14 performs error detection using the ID portions of the physical addresses ID1 and ID2 and the error detection code CRC and outputs a decision result X and the read address IDR.

When the decision result X is normal, reading of the read data RDDATA read from the data portion 11 on the sector of interest takes place.

The recording capacity of a recording medium, such as an MO, can be increased by improving the data recording density for the data portion 11 using a recording format, such as MSR (Magnetically induced Super Resolution). Because data in the header portion 10 is recorded by embossing, however, the length of a recording mark in the header portion 10 cannot be made smaller than the spot size of the laser beam.

As shown in FIG. 6, when the recording density of the data portion 11 is increased from a single density (1×) corresponding to 640 MB to a double density (2×) corresponding to 1.3 GB, a triple density (3×) corresponding to 2.3 GB or a multiple density (X-times), the recording field of the header portion 10 is constant while the recording field of the data portion 11 per sector decreases. Therefore, the higher the recording density of the data, the greater the ratio per sector of the header portion 10 occupying the recording field to the data. It is therefore desirable to reduce the recording field of the header portion 10, particularly the recording fields of the VFO fields VFO1 and VFO2 that occupy nearly 2/3 of the recording field of the header portion 10. According to the prior art, however, the VFO fields VFO1 and VFO2 are essential to synchronize the read clock signal RDCLK with the read data RDDATA prior to reading of the address mark AM.

### SUMMARY OF THE INVENTION

Accordingly, it is an object of the present invention to provide a data reading apparatus which can make the recording field of a header portion smaller.

One aspect of the present is an apparatus for reading data from a disk, wherein the data is recorded in a data portion provided in each sector on the disk based on address information recorded in a header portion provided in that sector. The apparatus includes a read clock generating circuit for generating a read clock signal based on rotational speed and recording density of the disk.

A further perspective of the present invention is an apparatus for reading data recorded on a disk having sectors with each sector including a header portion having an address sync mark and address information and a data portion where the data is recorded. The apparatus includes a read clock generating circuit for generating a read clock signal based on a rotational speed and recording density of the disk. A first ID reading apparatus operates in accordance with the read clock signal. The first ID reading apparatus includes a first address sync mark detection circuit for detecting the address sync mark from data read from the header portion in accordance with the read clock signal and generating an address sync mark detection signal, a first ID reading circuit for reading address information from the read data in accordance with the address sync mark detection signal and the read clock signal, and a first ID decision circuit for generating a read address read from the address information and a decision result indicating whether the read address is normal in accordance with the read clock signal. The apparatus further includes a plurality of delay circuits for generating a plurality of delay clock signals having different phases from one another from the read clock signal, a plurality of second ID reading apparatuses which operate in accordance with the plurality of delay clock signals. The second ID reading apparatuses includes a second address sync mark detection circuit for detecting the address sync mark from data read from the header portion in accordance with an associated one of the plurality of delay clock signals and generating an address sync mark detection signal, a second ID reading circuit for reading address information from the read data in accordance with the address sync mark detection signal and the associated one of the plurality of delay clock signals, and a second ID decision circuit for generating a read address read from the address information and a decision result indicating whether the read address is normal in accordance with the associated one of the plurality of delay clock signals. A selector circuit receives a plurality of read addresses and a plurality of decision results from the first reading apparatus and the plurality of second reading apparatuses and selects a best read address and decision result from thereamong.

A further perspective of the present invention is a method of reading data from a disk. The method includes generating a read clock signal based on rotational speed and recording density of the disk, reading address information from a header portion recorded in each sector of the disk in accordance with the read clock signal, and reading data recorded in a data portion of each sector based on the address information.

A further perspective of the present invention is a method of reading data from a disk. The method includes generating a read clock signal based on rotational speed and recording density of the disk, generating a plurality of delay clock signals having different phases from one another from the read clock signal, reading address information recorded in a header portion of each sector of the disk in accordance with the read clock signal, reading the address information in accordance with the plurality of delay clock signals, selecting the address information which has the greatest number of matches from the address information read at different timings, and reading the data based on the selected address information.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram showing a conventional data reading apparatus;

FIG. 2 is a block diagram showing the structure of a controller section;

FIG. 3 is an explanatory diagram showing the structure of a sector;

FIG. 4 is a timing waveform chart illustrating a conventional data reading operation;

FIG. 5 is a block diagram showing the structure of a conventional formatter;

FIG. 6 is an explanatory diagram showing the occupying ratios of the header portion and data portions;

FIGS. 7 and 8A are block diagrams of a data reading apparatus according to a first embodiment of the present invention;

FIG. 8B is a block diagram of an address comparing circuit;

FIG. 8C is a table showing the comparison results;

FIG. 9 is a waveform chart for a clock signal according to the first embodiment;

FIG. 10 is a circuit diagram showing first and second delay circuits;

FIG. 11 is an explanatory diagram showing a table of read clock signals;

FIG. 12 is an explanatory diagram illustrating the operations of the address comparing circuit and an output circuit;

FIG. 13 is a circuit diagram showing another example of first and second delay circuits; and

FIG. 14 is a timing waveform chart illustrating the operations of first and second delay circuits in FIG. 13.

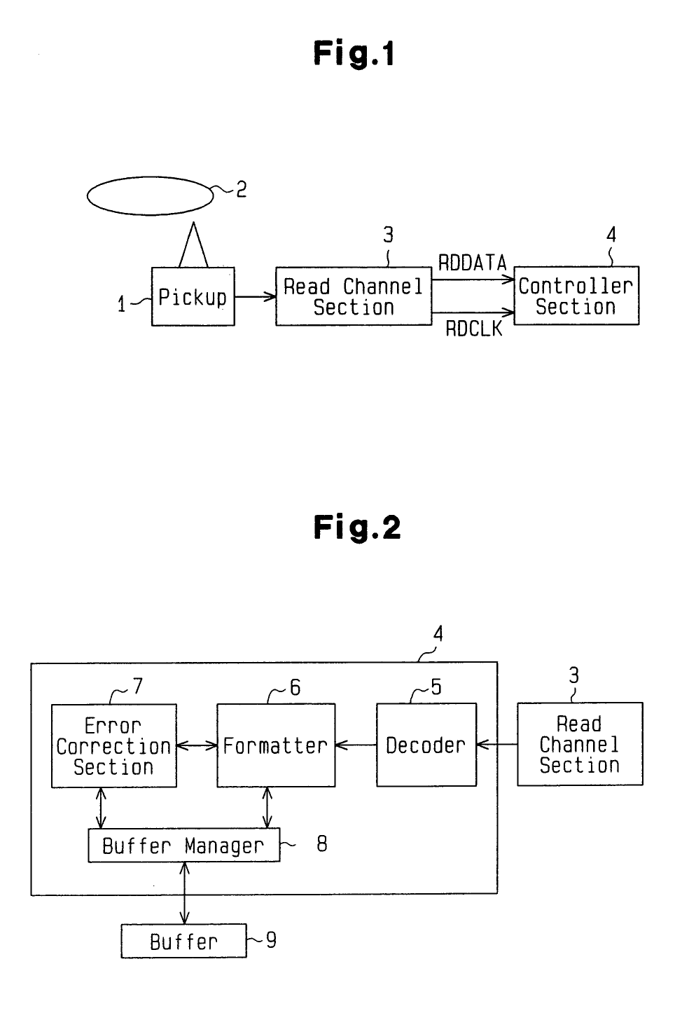

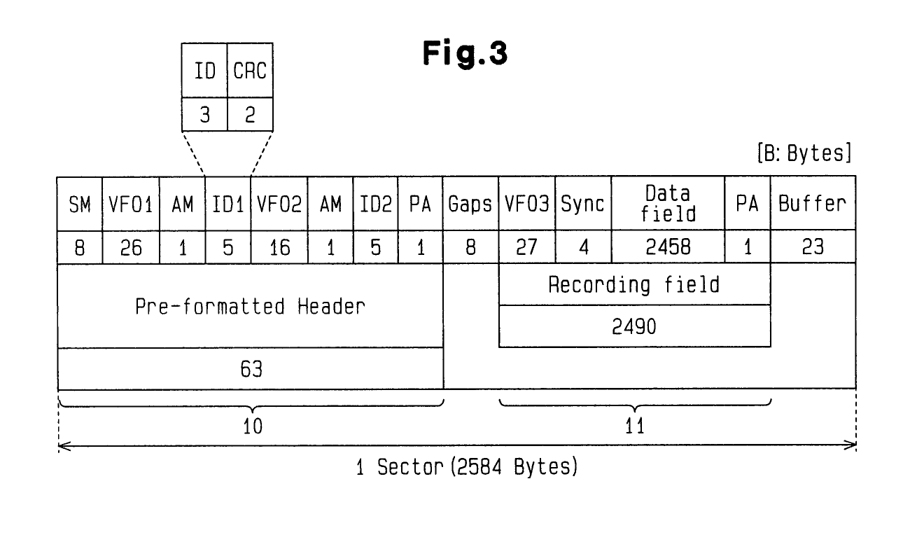

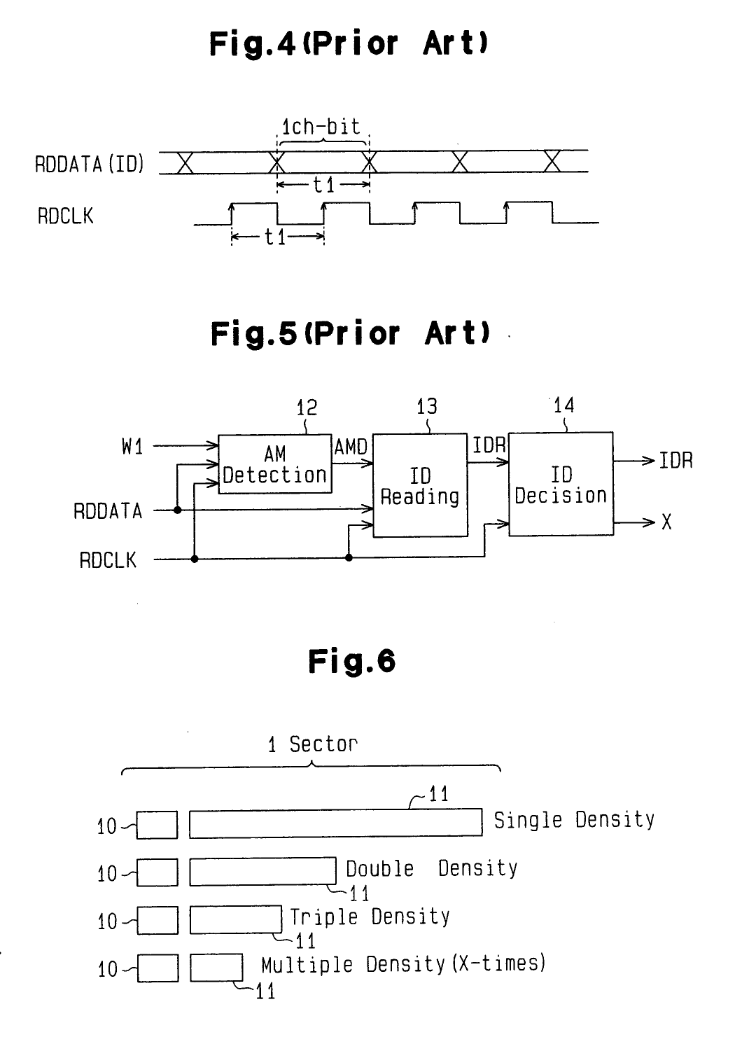

### DETAILED DESCRIPTION OF THE PREFERRED EMBODIMENTS

A data reading apparatus according to the first embodiment of the present invention will be described below. The data reading apparatus according to the first embodiment has an improved version of the formatter 6 in FIG. 5. Therefore, the data reading apparatus is the same as the one shown in FIG. 5 except for the formatter 6. The following description will discuss the data reading apparatus which uses an MO as a recording medium. It should therefore be understood that the terms “address mark”, “AM detection signal” and “AM detection circuit” would respectively indicate the terms “address sync mark”, “address sync mark detection signal” and “address sync mark detection circuit” which are used for recording media other than MO.

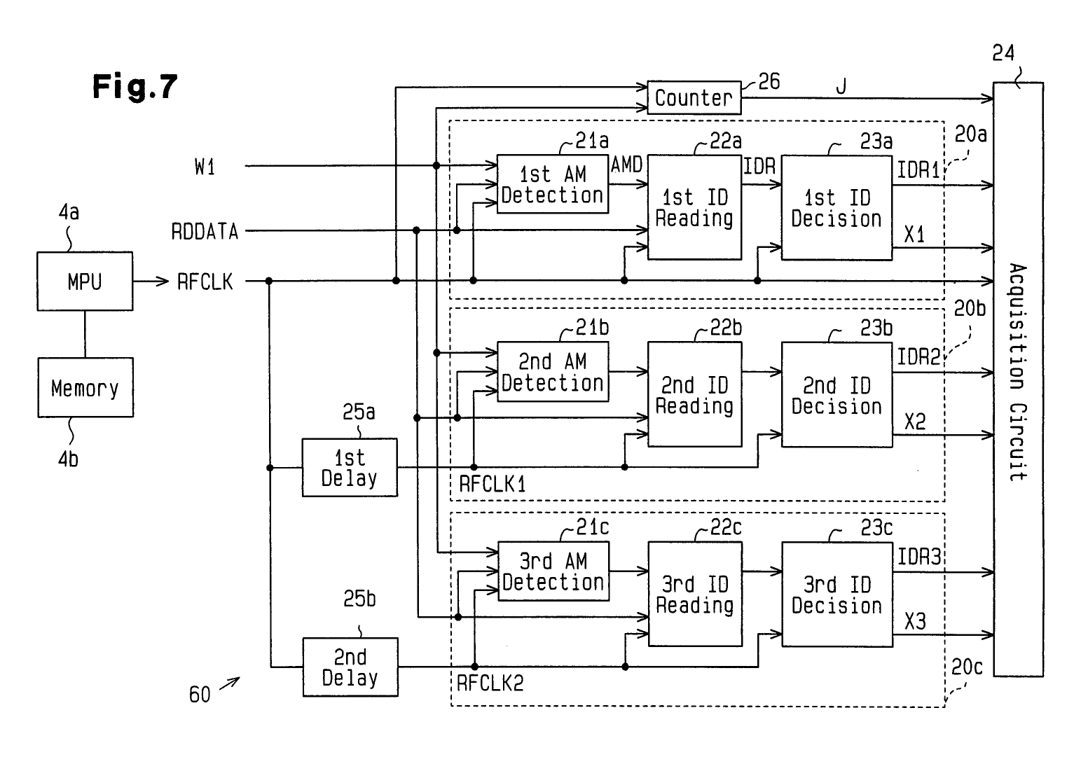

As shown in FIG. 7, the data reading apparatus of the first embodiment has a formatter 60 which includes a first AM detection circuit 21a, a second AM detection circuit 21b, third AM detection circuit 21c, a first ID reading circuit 22a, a second ID reading circuit 22b, a third ID reading circuit 22c, a first ID decision circuit 23a, a second ID decision circuit 23b, and a third ID decision circuit 23c. Each of the first to third AM detection circuits 21a to 21c is the same as the conventional AM detection circuit 12 shown in FIG. 5, and each of the first to third ID reading circuits 22a to 22c is the same as the conventional ID reading circuit 13. Each of the first to third ID decision circuits 23a to 23c is the same as the conventional ID decision circuit 14. The first AM detection circuit 21a, the first ID reading circuit 22a and the first ID decision circuit 23a constitute a first ID reading apparatus 20a. The second AM detection circuit 21b, the second ID reading circuit 22b and the second ID decision circuit 23b constitute a second ID reading apparatus 20b. The third AM detection circuit 21c, the third ID reading circuit 22c and the third ID decision circuit 23c constitute a third ID reading apparatus 20c.

A read clock signal RFCLK and read data RDDATA are provided to the first AM detection circuit 21a. Prior to reading of an address mark AM, an AM detection window signal W1 generated in the formatter 6 is provided to the first AM detection circuit 21a. The frequency of the read clock signal RFCLK calculated by, for example, an MPU (arithmetic operation circuit) 4a which controls the aforementioned controller section 4. When detecting the address mark AM in the read data RDDATA, the first AM detection circuit 21a provides an address mark detection signal AMD to the first ID reading circuit 22a.

The read clock signal RFCLK, read data RDDATA and address mark detection signal AMD are provided to the first ID reading circuit 22a. When receiving the address mark detection signal AMD, the first ID reading circuit 22a samples physical addresses ID1 and ID2 (address information) provided as the read data RDDATA according to the read clock signal RFCLK, thereby generating read address IDR, and provides the read address IDR to the first ID decision circuit 23a.

The first ID decision circuit 23a determines the read address IDR based on the read clock signal RFCLK. That is, the first ID decision circuit 23a performs error detection using the ID portions of the physical addresses ID1 and ID2 and the error detection code CRC and sends an error detection result (decision result) X1 and the read address IDR1 to an acquisition circuit 24.

A first delay circuit 25a generates a first delay read clock signal RFCLK1 from the read clock signal RFCLK and provides the clock signal RFCLK1 to the second AM detection circuit 21b, the second ID reading circuit 22b and the second ID decision circuit 23b. The second AM detection circuit 21b, the second ID reading circuit 22b and the second ID decision circuit 23b respectively operate in the same manner as the first AM detection circuit 21a, the first ID reading circuit 22a and the first ID decision circuit 23a in accordance with the first delay read clock signal RFCLK1. The second ID decision circuit 23b sends a decision result X2 and a read address IDR2 to the acquisition circuit 24.

A second delay circuit 25b generates a second delay read clock signal RFCLK2 from the read clock signal RFCLK and provides the clock signal RFCLK2 to the third AM detection circuit 21c, the third ID reading circuit 22c and the third ID decision circuit 23c. The third AM detection circuit 21c, the third ID reading circuit 22c and the third ID decision circuit 23c respectively operate in the same manner as the first AM detection circuit 21a, the first ID reading circuit 22a and the first ID decision circuit 23a in accordance with the second delay read clock signal RFCLK2. The third ID decision circuit 23c sends a decision result X3 and a read address IDR3 to the acquisition circuit 24.

The AM detection window signal W1 and the read clock signal RFCLK are provided to a counter circuit 26. The counter circuit 26 starts counting the read clock signal RFCLK in response to the termination of the supply of the AM detection window signal W1. After a predetermined time elapses since the termination of the supply of the AM detection window signal W1, the counter circuit 26 provides a decision timing signal J to the acquisition circuit 24. The output timing for the decision timing signal J is set in such a way that the decision timing signal J is output after the read addresses IDR1 to IDR3 and the decision results X1 to X3 are output from the first to third ID decision circuits 23a to 23c.

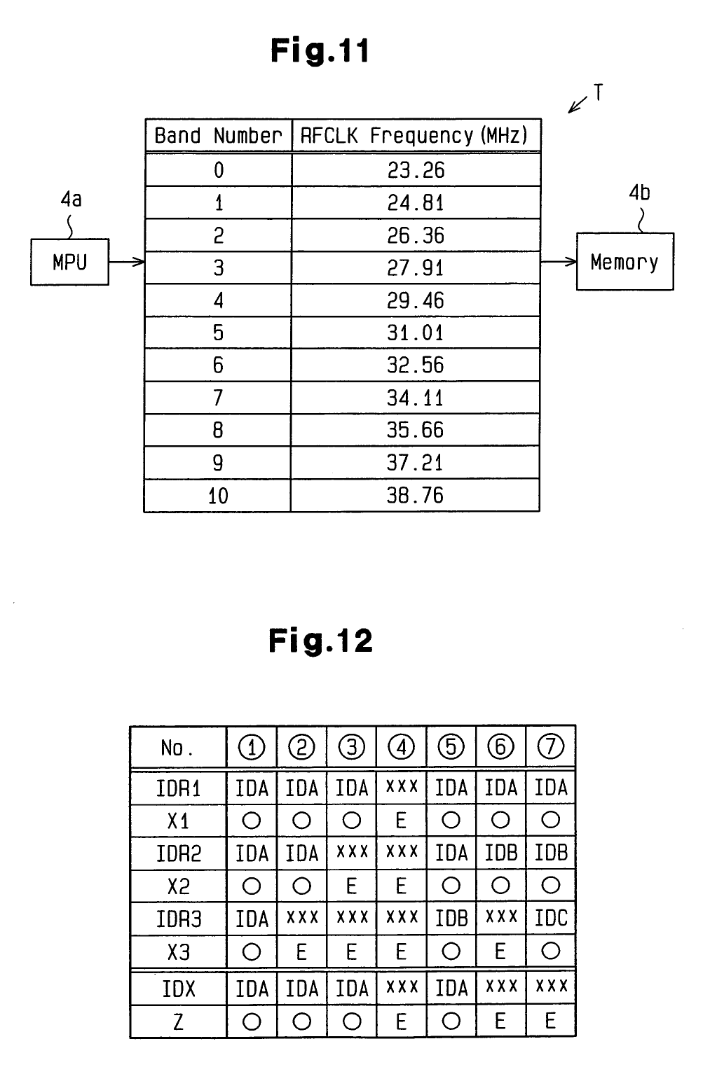

The frequency of the read clock signal RFCLK is computed by, for example, the MPU 4a from the average rotational speed and the recording density of a disk 2. The frequency of the read clock signal RFCLK is computed according to the average rotational speed and the recording density of the disk 2 and may be stored in a memory 4b as a table T shown in, for example, FIG. 11. In this case, the MPU 4a may select the read clock signal RFCLK from the table T in accordance with the average rotational speed and the recording density of the disk 2.

The table T in FIG. 11 shows the frequencies of the read clock signals RFCLK in a case where the recording medium 2 is a 640-MB MO and the average rotational speed is 50 Hz. In FIG. 11, Band0 to Band10 correspond to a plurality of zones which are defined outward from the inner periphery of the disk and data is recorded in those zones at different recording densities. In case of a 640-MB MO, for example, one sector is 2584 Bytes. In case of data which has undergone RLL (1, 7) coding (Run-Length Limited coding), data is recorded in one sector at a density of 31008 ch-bits. Data (ch-bits) whose quantity is indicated by the following equation is recorded in each zone per single rotation of the disk.

(15+1×band number)×31008

In case of Band3, therefore, data of 558144 ch-bits is recorded per rotation of the disk and the data is read at the average rotational speed of 50 Hz. Therefore, the read clock signal RFCLK is computed by the following equation.

558144(ch-bits/rotation)×50(rotations/sec)=27.91MHz

According to this embodiment, the read clock signal generating circuit includes the MPU 4a which calculates the read clock signal RFCLK and/or the memory 4b which stores the table T.

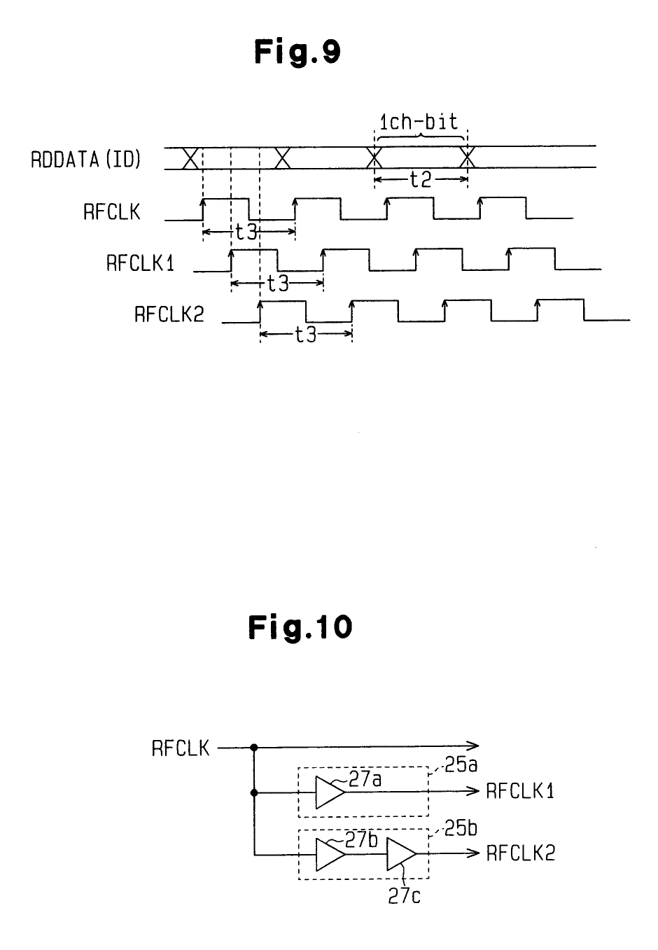

Due to eccentricity and rotational variation of the disk, the frequency of the read data RDDATA is usually altered. This causes a phase deviation (and a periodic deviation) between the read data RDDATA and the read clock signal RFCLK, which is calculated from the average rotational speed and the recording density of the disk, as shown in FIG. 9. In this embodiment, as the delays of the delay read clock signals RFCLK1 and RFCLK2 are set in such a way that at least one of the read clock signals RFCLK, RFCLK1 and RFCLK2 rises within a 1 ch-bit time of the read data RDDATA, at least one piece of correct data is acquired. Therefore, the read data RDDATA is read out by using plural read clock signals RFCLK, RFCLK1 and RFCLK2 which are not synchronous with the read data RDDATA.

In other words, if the deviation between the reading period with respect to 6-bytes data of address mark AM and address ID (72ch-bit) of the read data RDDATA and the corresponding cycles of the read clock signal RFCLK is within one period of the clock signal RFCLK, the address ID can be correctly read. That is, in a case where one period of the read clock signal RFCLK is 10 nsec and a period required to read the 6-bytes data of address mark AM and address ID (72ch-bit) is 720 nsec±10 nsec (72ch-bit±1ch-bit), the address ID can be read using the read clock signals RFCLK, RFCLK1 and RFCLK2.

As shown in FIG. 10, the first delay circuit 25a includes a buffer circuit 27a and the second delay circuit 25b includes buffer circuits 27b and 27c. As shown in FIG. 9, the first and second delay read clock signals RFCLK1 and RFCLK2 are delayed with respect to the read clock signal RFCLK.

The first and second delay read clock signals RFCLK1 and RFCLK2 are generated in such a way that the phase difference between the read clock signal RFCLK and the first delay read clock signal RFCLK1 becomes the same phase difference between the first delay read clock signal RFCLK1 and the second delay read clock signal RFCLK2, and the phase difference between the read clock signal RFCLK and the second delay read clock signal RFCLK2 does not exceed the period (t2) of the read data RDDATA.

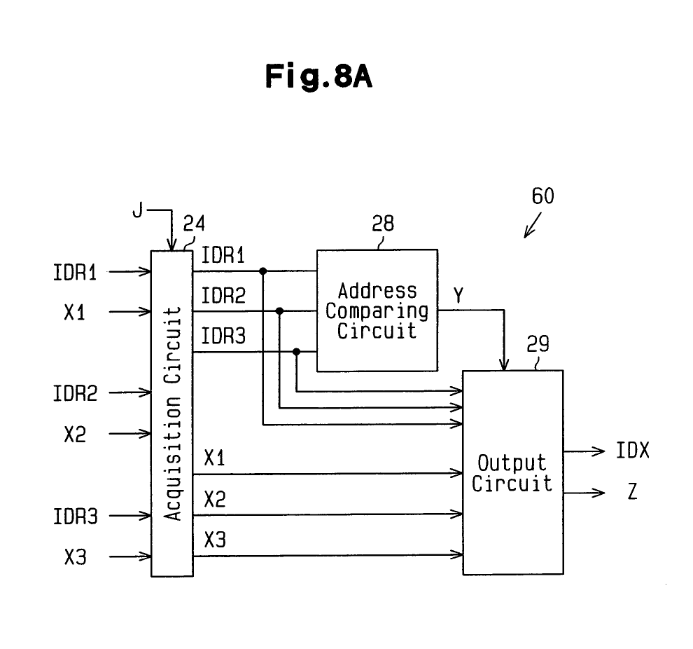

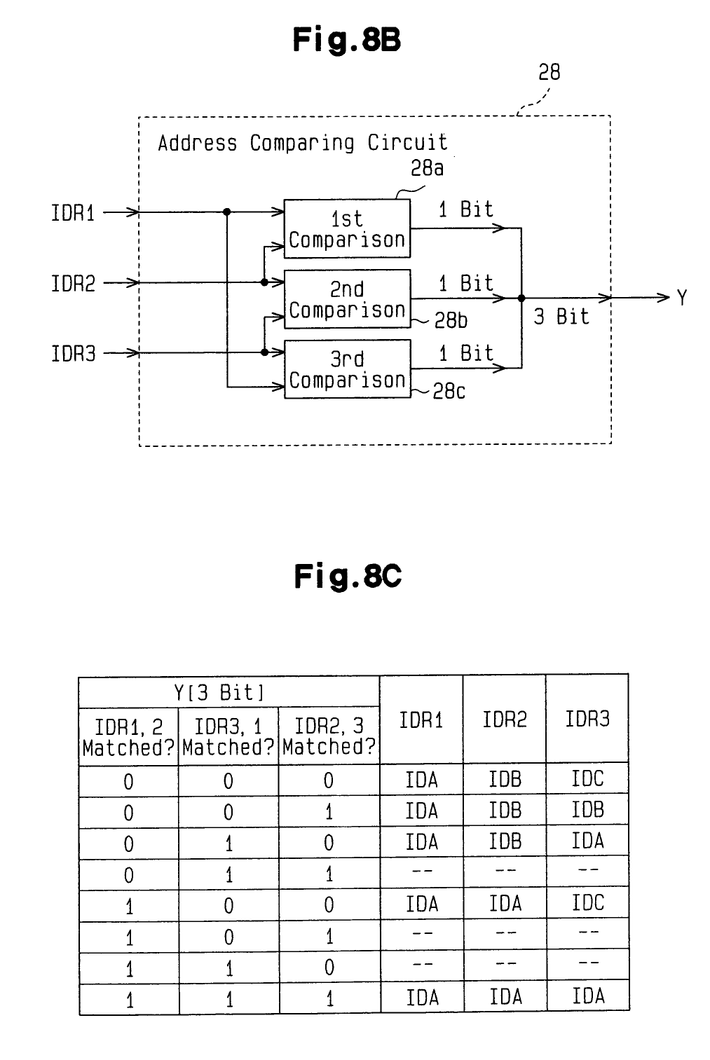

The acquisition circuit 24 acquires the read addresses IDR1 to IDR3 and the decision results X1 to X3 in accordance with the decision timing signal J. As shown in FIG. 8, the acquisition circuit 24 provides the read addresses IDR1 to IDR3 to an address comparing circuit 28 and an output circuit 29 and provides the decision results X1 to X3 to the output circuit 29.

The address comparing circuit 28 compares the read addresses IDR1 to IDR3 with one another and provides the output circuit 29 with a comparison result Y indicating whether the addresses IDR1 to IDR3 coincide with one another. As shown in FIG. 8B, the address comparing circuit 28 includes a comparison circuit 28a, which compares the read addresses IDR1 and IDR2 with each other and generates a comparison result for the addresses IDR1 and IDR2, a comparison circuit 28b which compares the read addresses IDR2 and IDR3 with each other and generates a comparison result for the addresses IDR2 and IDR3, and a comparison circuit 28c which compares the read addresses IDR3 and IDR1 with each other and generates a comparison result for the addresses IDR3 and IDR1. As shown in FIG. 8C, the comparison result Y for the three signals is a 3-bit digital signal. In FIG. 8C, “1” indicates that two addresses that have been compared coincide with each other, “0” indicates that two addresses do not coincide with each other, and “--” indicates an impossible combination. The output circuit 29 outputs the comparison result Y, an address value IDX which is selected in accordance with the read addresses IDR1 to IDR3 and decision results X1 to X3, and a decision result Z.

The operation of the data reading apparatus according to the first embodiment will be discussed below.

At the time of reading data, read data RDDATA is provided to the formatter 6 via a decoder 5 from a read channel section 3. The formatter 6 is provided with the read clock signal RFCLK that has been calculated from the average rotational speed and the recording density of the disk. Then, the first and second delay circuits 25a and 25b generate the delay read clock signals RFCLK1 and RFCLK2.

The first AM detection circuit 21a, the first ID reading circuit 22a and the first ID decision circuit 23a operate in accordance with the read clock signal RFCLK, the second AM detection circuit 21b, the second ID reading circuit 22b and the second ID decision circuit 23b operate in accordance with the first delay read clock signal RFCLK1, and the third AM detection circuit 21c, the third ID reading circuit 22c and the third ID decision circuit 23c operate in accordance with the second delay read clock signal RFCLK2.

As shown in FIG. 9, therefore, the physical addresses ID1 and ID2 provided as the read data RDDATA are read out in accordance with the three kinds of read clock signals RFCLK, RFCLK1 and RFCLK2. Then, the read addresses IDR1 to IDR3 and the decision results X1 to X3 are provided to the acquisition circuit 24 from the first to third ID decision circuits 23a to 23c.

The acquisition circuit 24 acquires the read addresses IDR1 to IDR3 and the decision results X1 to X3 in accordance with the decision timing signal J. The acquisition circuit 24 provides the read addresses IDR1 to IDR3 to the address comparing circuit 28 and the output circuit 29 and provides the decision results X1 to X3 to the output circuit 29. The acquisition circuit 24, the address comparing circuit 28 and the output circuit 29 constitute a selector circuit.

The output circuit 29 outputs the address value IDX selected from the read addresses IDR1 to IDR3 according to the comparison result Y and the decision results X1 to X3 and the decision result Z corresponding to the selected address value (i.e., one of X1 to X3). Accordingly, the output circuit 29 performs an operation as illustrated in FIG. 12. In FIG. 12, IDA to IDC in the rows of the read addresses IDR1 to IDR3 are ID values read out, and “XXX” is an undetermined value when an address value has not been acquired. Further, marks “O” in the rows of the decision results X1 to X3 indicate no error and “E” indicates presence of an error.

In case 1, the address values of the read addresses IDR1 to IDR3 all take the same value of IDA and IDA is thus in the majority in the read addresses IDR1 to IDR3. All of the decision results X1 to X3 indicate no error. In this case, IDA is output as the address value IDX from the output circuit 29 by as it is in the majority and the decision result Z indicates no error present.

In case 2, the address values of the read addresses IDR1 and IDR2 take the same value of IDA and the decision results X1 and X2 indicate no error, while the address value of the read address IDR3 becomes undetermined and the decision result X3 indicates presence of an error. In this case, the address values of the read addresses IDR1 and IDR2 have a match and are in a majority. By majority rule, the address value IDX to be output from the output circuit 29 becomes IDA and the decision result Z indicates no error present.

In case 3, the address value of the read address IDR1 is IDA and the decision result X1 indicates no error, while the address values of the read addresses IDR2 and IDR3 become undetermined and the decision results X2 and X3 indicate presence of an error. The read addresses IDR2 and IDR3 for which the decision results X1 to X3 are in error (E) are not considered in the majority decision. Therefore, the error-free read address IDR1 has the majority and the address value IDX to be output from the output circuit 29 is IDA and the decision result Z indicates no error present.

In case 4, all the address values of the read addresses IDR1 to IDR3 is undetermined and the decision results X1 to X3 are all in error. In this case, the address value IDX to be output from the output circuit 29 becomes undetermined and the decision result Z indicates presence of an error.

In case 5, the address values of the read addresses IDR1 and IDR2 take the same value of IDA and the decision results X1 and X2 indicate no error, while the address value of the read address IDR3 is set to be IDB and the decision result X3 indicates no error. In this case, the address values of the read addresses IDR1 and IDR2 have a match and are in the majority. Therefore, the address value IDX to be output from the output circuit 29 is IDA, and the decision result Z indicates no error present.

In case 6, the address value of the read address IDR1 is IDA, the decision result X1 indicates no error, the address value of the read address IDR2 is IDB, the decision result X2 indicates no error, the address value of the read address IDR3 is undetermined and the decision result X3 is in error. In this case, no address values have a majority and it is uncertain which address value is best. Hence, there is no majority, and the undetermined address value XXX is output as the address value IDX and the decision result Z shows presence of an error.

In case 7, the address values of the read addresses IDR1 to IDR3 are different from one another and the decision results X1 to X3 all show no error. In this case, no address values have a majority and it is uncertain which address value is best. Therefore, the undetermined address value XXX is output as the address value IDX and the decision result Z shows presence of an error.

Through such an operation, if the output circuit 29 outputs the address value IDX and the decision result Z indicates no error, data is read from the data portion in the sector in question.

If the address value IDX to be output from the output circuit 29 becomes undetermined and the decision result Z indicates presence of an error, reading of data from the data portion of the sector of interest is stopped.

While the address value IDX is selected from the read addresses IDR1 to IDR3 and the decision result Z is also selected from the decision results X1 to X3, they may take different values.

The data reading apparatus according to the first embodiment has the following advantages.

(1) The physical addresses ID1 and ID2 are read out in accordance with the read clock signal RFCLK that is calculated from the average rotational speed of the disk and the recording density of the data. It is therefore unnecessary to provide the VFO fields VFO1 and VFO2 in the header portion 10. This allows the recording field of the header portion 10 to be made smaller, so that the recording capacity of the disk can be increased.

(2) The read clock signal RFCLK is not completely synchronized with the read data RDDATA of the physical addresses ID1 and ID2. Accordingly, the data reading apparatus generates plural delay read clock signals RFCLK1 and RFCLK2 by shifting the phase of the read clock signal RFCLK and reads out the read data RDDATA in accordance with the individual read clock signals RFCLK, RFCLK1 and RFCLK2. Therefore, the read data RDDATA can be read out reliably.

(3) The read addresses IDR1 to IDR3, which have been read respectively in accordance with plural read clock signals RFCLK, RFCLK1 and RFCLK2, and the decision results X1 to X3, which are results having been determined based on the error detection code CRC whether their address values are normal or not, are provided to the address comparing circuit 28 and the output circuit 29. Then, the address value IDX, which has been decided to have a majority by the address comparing circuit 28 and the output circuit 29, and the decision result Z are output. Therefore, the address value IDX most likely to be correct from the read addresses IDR1 to IDR3 and the decision result Z are output.

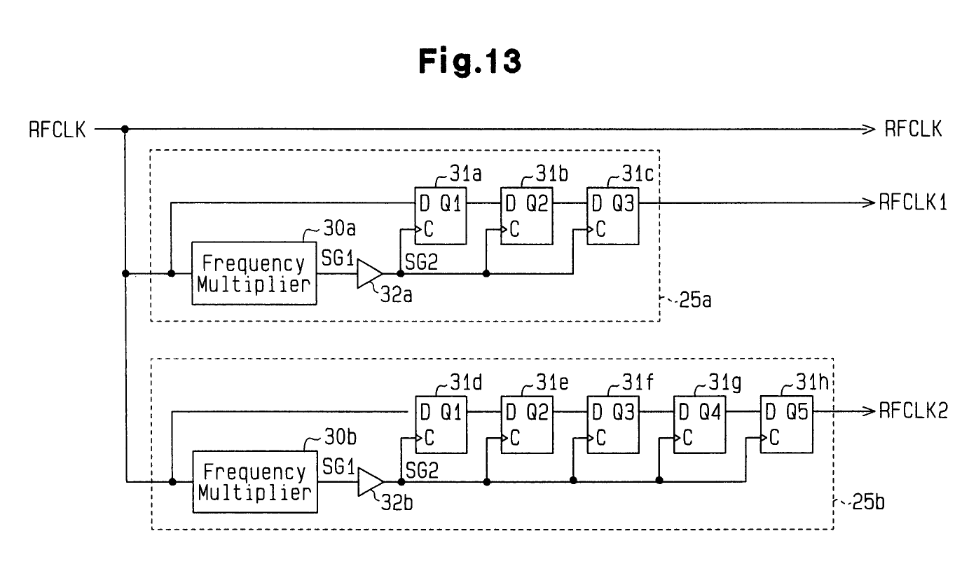

Referring to FIG. 13, a data reading apparatus according to the second embodiment will be discussed below. In the second embodiment, the first and second delay circuits 25a and 25b are modified.

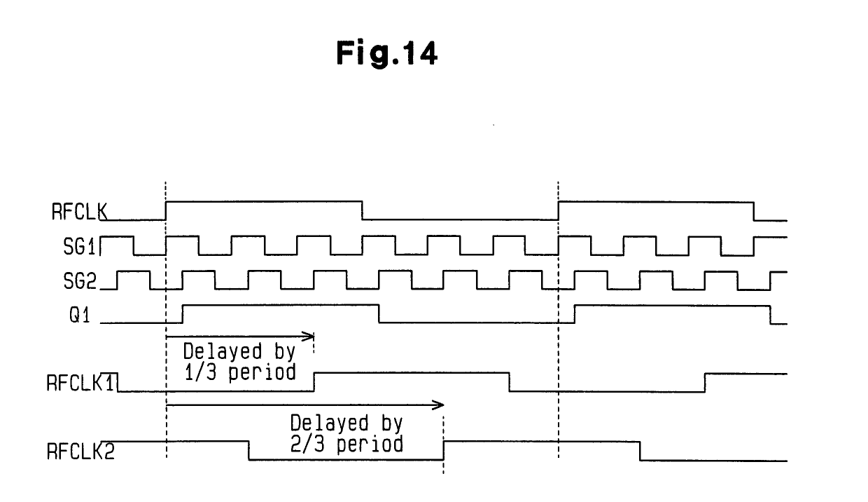

In the first delay circuit 25a, the read clock signal RFCLK is provided to a frequency multiplier 30a which constitutes a PLL circuit and is provided as data D to a flip-flop circuit 31a. The frequency multiplier 30a generates a conversion signal SG1 whose frequency is six times the frequency of the read clock signal RFCLK and sends the signal SG1 to a buffer circuit 32a, as shown in FIG. 14. The buffer circuit 32a generates an output signal SG2 by shifting the phase of the conversion signal SG1 by a quarter of the period and sends the signal SG2 as a clock signal C to flip-flop circuits 31a to 31c.

The flip-flop circuit 31a outputs the data D as an output signal Q1 in response to the rising of the clock signal C. The output signal Q1 is provided as data D to the flip-flop circuit 31b.

Therefore, the output signal Q1 is a signal which is delayed from the read clock signal RFCLK by a quarter of the period of the output signal SG1 of the frequency multiplier 30a.

The flip-flop circuit 31b outputs the data D as an output signal Q2 in response to the rising of the clock signal C. The output signal Q2 is provided as data D to the flip-flop circuit 31c.

The flip-flop circuit 31c outputs the data D as an output signal Q3 in response to the rising of the clock signal C. The output signal Q3 is output as the first delay read clock signal RFCLK1.

Through the operations of the flip-flop circuits 31b and 31c, the first delay read clock signal RFCLK1 results in a signal that is delayed from the read clock signal RFCLK by nearly ⅓ of the period, as shown in FIG. 14.

The second delay circuit 25b comprises a frequency multiplier 30b, a buffer circuit 32b and flip-flop circuits 31d to 31h. The second delay circuit 25b has an additional two stages of flip-flop circuits as compared with the first delay circuit 25a and is the same as the first delay circuit 25a in other structure.

In the second delay circuit 25b, therefore, the second delay read clock signal RFCLK2 which is delayed from the read clock signal RFCLK by ⅔ of the period is generated and is output from the flip-flop circuit 31h.

A data reading apparatus which is similar to that of the first embodiment can be constructed by using the above described first and second delay circuits 25a and 25b.

It should be apparent to those skilled in the art that the present invention may be embodied in many other specific forms without departing from the spirit or scope of the invention. Particularly, it should be understood that the present invention may be embodied in the following forms.

Three or more kinds of read clock signals of different phases from one another may be generated and a majority decision may be made based on a larger number of read addresses and decision results.

Although in the foregoing description of the preferred embodiments, an example has been given in which both the header portion and data portion have a lx recording density, the recording density of the data portion may be double or greater. For example, with the recording density of the header portion being a reference, the read clock signal RFCLK can be used even if the recording density of the data portion is a double density. With the recording density of the data portion being a reference, on the other hand, the data length of the header portion becomes twice as long as the data length of the data portion. In a case where the period of the data portion is T, therefore, the period of data in the header portion becomes 2T and the period of the read clock signal RFCLK in the header portion is set to 2T.

The present examples and embodiments are to be considered as illustrative and not restrictive, and the invention is not to be limited to the details given herein, but may be modified within the scope and equivalence of the appended claims.

What is claimed is:

1. An apparatus for reading data from a disk, wherein the data is recorded in a data portion provided in each sector on the disk based on address information recorded in a header portion provided in that sector, the apparatus comprising:
a read clock generating circuit for generating a read clock signal based on rotational speed and recording density of the disk.

2. The apparatus according to claim 1, wherein the disk has a plurality of zones where data is recorded in those zones at different recording densities and the read clock generating circuit includes an arithmetic operation circuit for computing a frequency of the read clock signal in accordance with the rotational speed of the disk and the recording density of each zone.

3. The apparatus according to claim 1, wherein the disk has a plurality of zones where data is recorded in those zones at different recording densities, a frequency of the read clock signal differs zone by zone, and the read clock generating circuit includes a memory where a table of frequencies of a plurality of read clock signals associated with the plurality of zones is stored.

4. The apparatus according to claim 1, further comprising an ID reading apparatus which operates in accordance with the read clock signal to read the address information and the data.

5. The apparatus according to claim 1, further comprising:
a first delay circuit for generating from the read clock signal a first delay clock signal delayed by a predetermined phase from the read clock signal; and
a second delay circuit for generating from the read clock signal a second delay clock signal delayed by the predetermined phase from the first delay clock signal.

6. An apparatus for reading data recorded on a disk having sectors with each sector including a header portion having an address sync mark and address information and a data portion where the data is recorded, the apparatus comprising:
a read clock generating circuit for generating a read clock signal based on a rotational speed and recording density of the disk;
a first ID reading apparatus which operates in accordance with the read clock signal, the first ID reading apparatuses including:
a first address sync mark detection circuit for detecting the address sync mark from data read from the header portion in accordance with the read clock signal and generating an address sync mark detection signal;
a first ID reading circuit for reading address information from the read data in accordance with the address sync mark detection signal and the read clock signal; and
a first ID decision circuit for generating a read address read from the address information and a decision result indicating whether the read address is normal in accordance with the read clock signal;
a plurality of delay circuits for generating a plurality of delay clock signals having different phases from one another from the read clock signal;
a plurality of second ID reading apparatuses which operate in accordance with the plurality of delay clock signals, the second ID reading apparatuses including:
a second address sync mark detection circuit for detecting the address sync mark from data read from the header portion in accordance with an associated one of the plurality of delay clock signals and generating an address sync mark detection signal;
a second ID reading circuit for reading address information from the read data in accordance with the address sync mark detection signal and the associated one of the plurality of delay clock signals; and
a second ID decision circuit for generating a read address read from the address information and a decision result indicating whether the read address is normal in accordance with the associated one of the plurality of delay clock signals; and
a selector circuit which receives a plurality of read addresses and a plurality of decision results from the first reading apparatus and the plurality of second reading apparatuses and selects a best read address and decision result from thereamong.

7. The apparatus according to claim 6, wherein the selector circuit selects the best read address from the plurality of read addresses based on which read address is in a majority among the read addresses.

8. The apparatus according to claim 7, wherein the selector circuit includes an address comparing circuit for deciding which read address matches the greatest number of other read addresses among the plurality of read addresses; and
an output circuit for outputting the read address having the greatest number of matches and a decision result corresponding to the read address having the greatest number of matches based on an output decision from the address comparing circuit.

9. The apparatus according to claim 6, wherein each of the first and second delay circuits includes at least one buffer circuit for delaying the read clock signal.

10. The apparatus according to claim 9, wherein the number of the at least one buffer circuit of the first delay circuit differs from that of the second delay circuit.

11. The apparatus according to claim 6, wherein each of the first and second delay circuits includes:
a frequency multiplier for multiplying a frequency of the read clock signal; and
flip-flop circuits connected in series to one another, to each of which a multiplied clock signal is provided from the frequency multiplier and to a first stage of which the read clock signal is provided.

12. A method of reading data from a disk, the method comprising:
generating a read clock signal based on rotational speed and recording density of the disk;
reading address information from a header portion recorded in each sector of the disk in accordance with the read clock signal; and
reading data recorded in a data portion of each sector based on the address information.

13. The method according to claim 12, wherein said generating the read clock signal includes computation of a frequency of the read clock signal in accordance with the rotational speed and recording density of the disk.

14. The method according to claim 12, further comprising generating a plurality of delay clock signals having different phases from one another from the read clock signal.

15. The method according to claim 14, wherein said reading the address information includes reading of the address information at different timings in accordance with the plurality of delay clock signals.

16. The method according to claim 15, further comprising selecting a best read address and error detection result from the read addresses read at different timings and error detection results for the read addresses.

17. A method of reading data from a disk, the method comprising:
generating a read clock signal based on rotational speed and recording density of the disk;
generating a plurality of delay clock signals having different phases from one another from the read clock signal;
reading address information recorded in a header portion of each sector of the disk in accordance with the read clock signal;
reading the address information in accordance with the plurality of delay clock signals;
selecting the address information which has the greatest number of matches from the address information read at different timings; and
reading the data based on the selected address information.

18. The method according to claim 17, wherein said generating the read clock signal includes computation of a frequency of the read clock signal in accordance with the rotational speed and recording density of the disk.
